(19) United States
(12) Patent Application Publication
(10) Pub. No.: US 2011/0247963 A1
(43) Pub. Date: Oct. 13, 2011

(54) Assistance Kit with Talking Instruction Card

(75) Inventor: Rick L. Stockett, Carefree, AZ (US)

(73) Assignee: CAREFREE TRADING, INC. D/B/A CFT, INC., Phoenix, AZ (US)

(21) Appl. No.: 12/758,591

(22) Filed: Apr. 12, 2010

(51) Int. Cl. B65D 71/00; G09B 23/28; G09B 5/04

(52) U.S. Cl. 206/572; 434/319; 434/265

(57) ABSTRACT

An assistance kit for providing a particular assistance or performing a particular procedure includes a card having first and second flaps hingedly coupled to one another such that the first and second flaps are moveable between an opened and closed position relative one another. An audio instruction unit is affixed to the card and is adapted to provide audible instructions for providing the particular assistance or performing the particular procedure, when activated by moving the first and second flaps of the card from the closed position to the opened position.

### FIELD OF TECHNOLOGY

The present disclosure relates generally to assistance kits such as for providing first aid or any other type of assistance and, more particularly, to kits that provide audible, situation-specific instructions to an assistance provider on how to assist in a particular situation where assistance or instruction may be beneficial.

### DESCRIPTION OF THE RELATED ART

First aid and other treatment for many frequently encountered medical and other conditions often must be provided by individuals who have not been trained to provide the required first aid or other treatment. Further, in many instances, individuals who must provide assistance or perform a procedure have minimal to no time to obtain instructions on how to provide the assistance or perform the procedure before actually providing or performing it, particularly in situations where the assistance or procedure may be critical or life-saving and thus must be provided or performed immediately. Further, even when time permits an assistance provider to obtain instructions, the necessary instructions often are not readily available or are not available in a form that can be quickly and efficiently absorbed, understood, and applied by an assistance provider or person performing a procedure.

Previously, assistance kits and instructional aids have been used to facilitate providing medical treatment or other forms of assistance, or performing generally any type of procedure, either through printed or videotaped instructions explaining how to provide the assistance or perform the procedure. Such instructions have been provided either on a case-by-case basis for different types of treatment or other situations, or as a compilation of instructions for varying types of treatment or other situations. However, these approaches tend to provide very detailed, technical, and comprehensive explanations of the treatments or other assistance that may not be able to be reviewed and understood by an individual sufficiently quickly when faced with a need to provide immediate treatment or other assistance. Further, the need to search through a compilation of instructions, whether in printed or videotape form, to find the instructions needed for a particular situation may cost valuable seconds when the focus should instead be on providing the assistance or performing the procedure immediately. Still further, particularly when seconds count, it is important that the instructions be concise and enable the assistance provider to quickly learn what to do and then act in accordance with the instructions.

Others approaches involve treatment kits that provide detailed printed instructions for only a single type of treatment. However, in a crisis, such as, for example, when a person stops breathing and requires cardiopulmonary rescucitation, an anxious treatment provider may not be able to read, comprehend, and act upon written instructions quickly enough to save the person's life.

### SUMMARY OF THE DISCLOSURE

An assistance kit for providing a particular assistance or performing a particular procedure may be provided with a card having first and second flaps wherein the first flap is hingedly coupled to the second flap such that the first flap and the second flap are moveable between an opened position relative one another and a closed position relative to one another. An audio instruction unit may be affixed to the card and adapted to provide audible instructions for providing the particular assistance or performing the particular procedure, wherein the audio instruction unit is activated by moving the first and second flaps of the card from the closed position to the opened position.

The audio instruction unit may be turned on by moving the first and second flaps of the card from the closed position to the opened position relative to one another, and may be off when the first and second flaps of the card are in the closed position relative to one another. The audio instruction unit may have an actuating tab which, when pulled, turns on the audio instruction unit. The actuating tab may turn the audio instruction unit off when the first and second flaps of the card are moved to the closed position relative to one another. The actuating tab may extend from the audio instruction unit between the first and second layers of the first flap and be fastened to the second flap such that the actuating tab is pulled thereby actuating the audio instruction unit when the first and second flaps are moved from the closed position to the opened position. The first flap may comprise first and second layers and the audio instruction unit may be disposed between the first and second layers of the first flap.

The assistance kit may further comprise a storage sleeve defining a cavity sized to removably receive the card, wherein the storage sleeve defines an opening through which the card is removable from the cavity.

An outer surface of the storage sleeve may bear a visible indication that the assistance kit provides audible instructions for providing the particular assistance or performing the particular procedure.

The first and second flaps of the card may be sized and spaced to receive, between the first and second flaps when in the closed position, at least one implement usable for providing the particular assistance or performing the particular procedure, and the assistance kit may further include at least one implement useable for providing the particular assistance or performing the particular procedure, wherein the at least one implement is positionable between the first and second flaps of the card.

In one embodiment the at least one implement may include at least one of a cardio-pulmonary resuscitation (CPR) mask, a pair of surgical gloves, a wipe, and a napkin.

### BRIEF DESCRIPTION OF THE DRAWINGS

FIG. 1 depicts an exemplary assistance kit including a talking instruction card inserted into a storage sleeve;

FIG. 2 depicts the exemplary assistance kit of FIG. 1, wherein the talking instruction card has been removed from the storage sleeve;

FIG. 3 depicts the talking instruction card of FIG. 2, having first and second flaps in an opened position relative to one another, together with exemplary implements positionable between the first and second flaps of the talking instruction card;

FIG. 4A depicts an end view of the talking instruction card of FIG. 3, with the first and second flaps in an opened position relative to one another;

FIG. 4B depicts an end view of the talking instruction card of FIG. 3, with the first and second flaps in a partially closed position relative to one another;

FIG. 5 depicts a partially cut-away view of a talking instruction card, illustrating an audio instruction unit affixed to a talking instruction card with the first and second flaps in a partially closed position;

FIG. 6 depicts a section view of a portion of the audio instruction unit affixed to the talking instruction card shown in FIG. 5;

FIG. 7 depicts a partially cut-away view of a talking instruction card, illustrating an audio instruction unit affixed to a talking instruction card with the first and second flaps in an opened position; and

FIG. 8 depicts a section view of a portion of the audio instruction unit affixed to the talking instruction card shown in FIG. 7.

### DETAILED DESCRIPTION

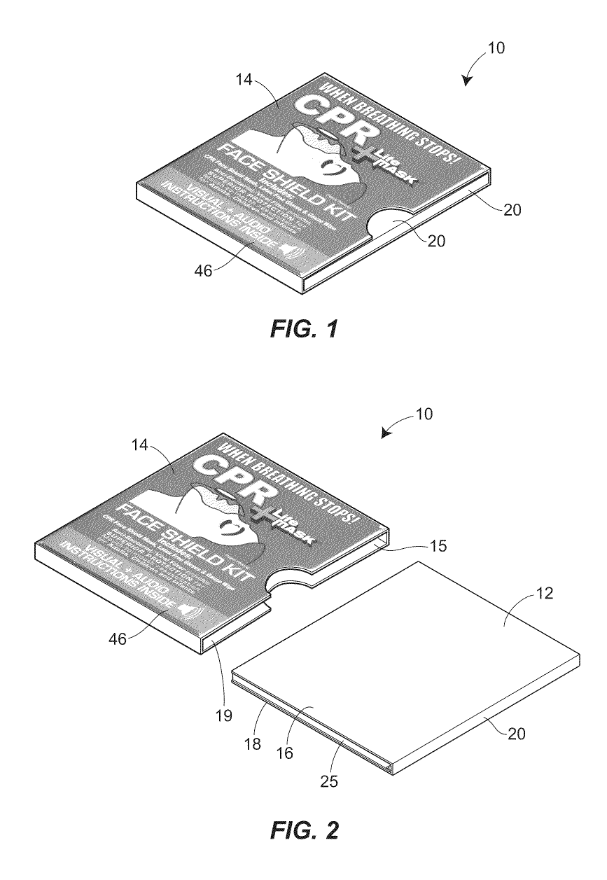

FIGS. 1 and 2 depict one embodiment of an assistance kit 10 for providing assistance in a particular situation or performing a particular procedure. The illustrated assistance kit 10 includes a card 12 and a storage sleeve 14 defining a cavity 15. The card 12 has a first flap 16 and a second flap 18, and the first flap 16 and the second flap 18 are moveable between an opened position relative to one another and a closed position relative to one another as explained in more detail below. The cavity 15 defined by the storage sleeve 14 is sized to removably receive the card 12 when the first flap 16 and the second flap 18 are in the closed position relative to one another. The storage sleeve 14 further defines an opening 19 into the cavity 15, and the opening 19 is sized such that the card 12 with the first and second flaps 16, 18 in the closed position is insertable into and removable from the cavity 15 through the opening 19.

The exemplary assistance kit 10 illustrated in FIG. 1 is a kit for use in providing cardiopulmonary resuscitation (CPR), but the principles of the present invention may be applied to provide an assistance kit for any of an enormous variety of particular situations or procedures where assistance may be required, as explained in more detail below. The card 12 and the storage sleeve 14 may be composed of cardboard, for example, and may be printed with information regarding the particular assistance or procedure in connection with which the assistance kit 10 is intended to be used, as well as printed instructions for providing the assistance or performing the procedure and any other desired or necessary information.

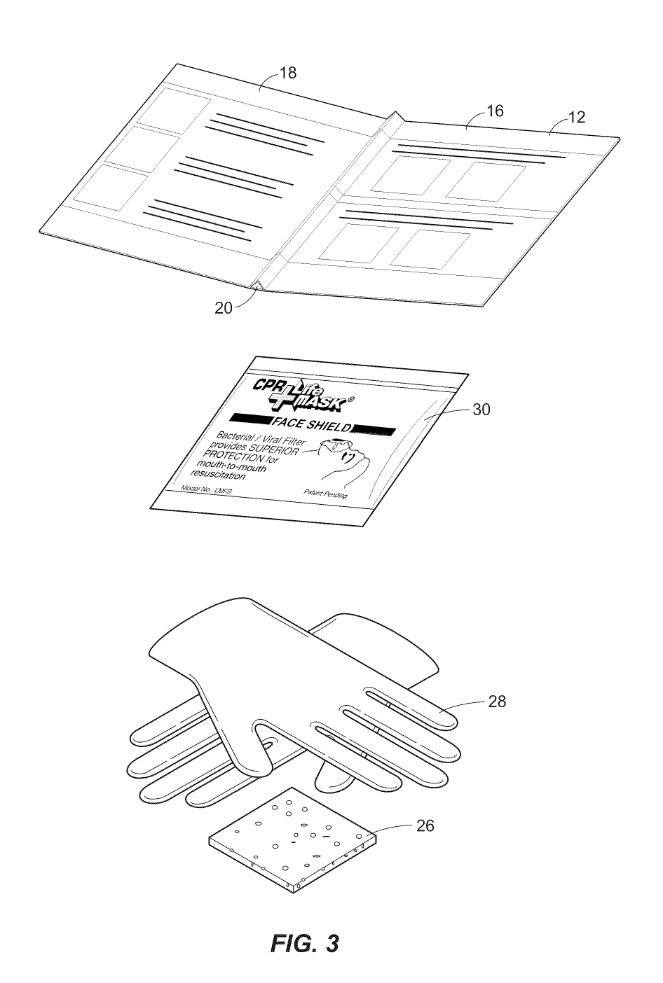

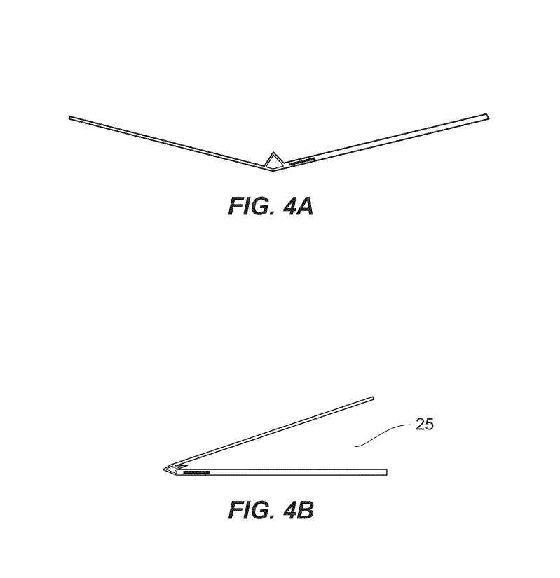

As shown in FIG. 2, the card 12 comprises a first flap 16 and a second flap 18 which may be integrally formed of a single folded card such that they are hingedly coupled to one another as shown, or the first flap 16 and the second flap 18 may comprise separate pieces otherwise hingedly joined together such as by a living hinge, binding, webbing, sidewall, or any other suitable means. By virtue of the hinged relationship between the first flap 16 and the second flap 18 of the card 12, the first flap 16 and the second flap 18 are moveable between a closed position relative to one another, as shown in FIG. 2, and an opened position relative to one another, as shown in FIG. 3. In the illustrated embodiment, the assistance kit 10 has a sidewall 20 integrally formed with and hingedly joining the first flap 16 and the second flap 18 such that the card 12 has a book-like appearance when the first flap 16 and the second flap 18 are in the closed position relative to one another, as illustrated in FIG. 2.

The assistance kit 10 may include one or more implements usable for providing assistance in the situation in which the treatment kit 10 is intended to be used or for performing the procedure for which the treatment kit 10 is intended to be used. For such assistance kits 10, the first flap 16 and the second flap 18 of the card 12 may be sized and spaced sufficiently far apart from one another to allow at least one such implement to be stored in a space 25 defined between the first flap 16 and the second flap 18 when the first flap 16 and the second flap 18 are in the closed position relative to one another. For example, implements provided in the assistance kit 10 shown in FIG. 3 include a gauze pad, napkin, or wipe 26, a pair of rubber gloves 28, and a cardio-pulmonary resuscitation mask or face shield 30, all of which may be used in performing CPR in accordance with instructions provided via the assistance kit 10 as explained below. Of course, those skilled in the art will appreciate that any other implements appropriate for use in providing any particular treatment may be included in an assistance kit intended for use in providing that particular treatment and that the implements shown are illustrative only.

The assistance kit 10 also includes an audio instruction unit 32 affixed to the card 12 and adapted to provide audible instructions to a user of the assistance kit 10 on, for example, how to provide assistance in the particular situation in which the assistance kit 10 is intended to be used (e.g., how to provide CPR in the case of the assistance kit 10 shown in FIG. 3). The audio instruction unit 32 is activated by moving the first flap 16 and the second flap 18 of the card 12 from the closed position relative to one another to the opened position relative to one another. More particularly, the audio instruction unit 32 is turned on by moving the first flap 16 and the second flap 18 of the card 12 from the closed position to the opened position relative to one another, and the audio instruction unit 32 is off when the first flap 16 and second flap 18 of the card 12 are in the closed position relative to one another.

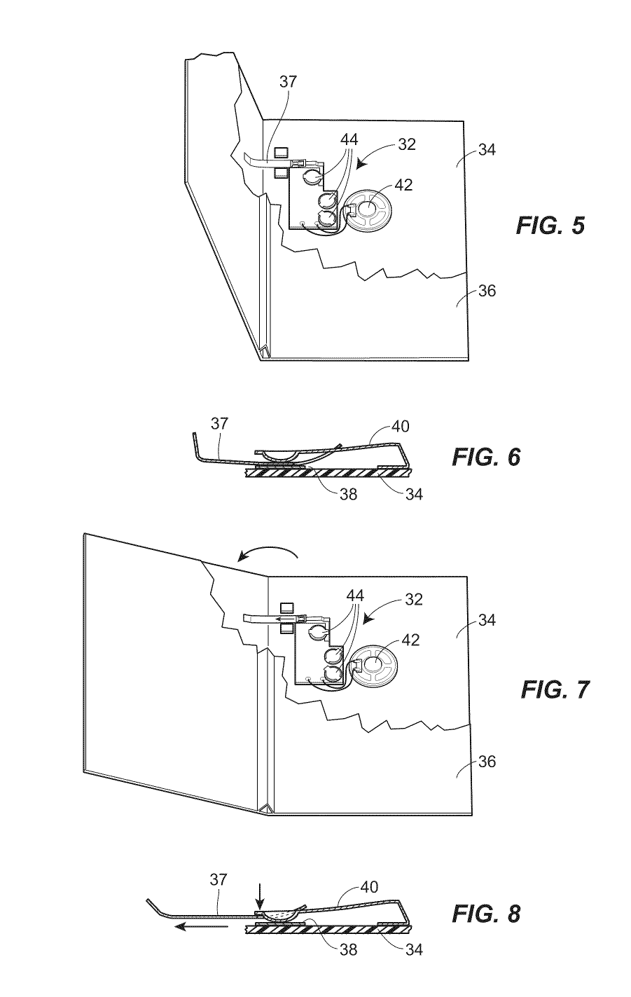

In the illustrated embodiment, the first flap 16 of the card 12 comprises a first layer 34 and a second layer 36, and the audio instruction unit 32 is disposed between the first layer 34 and the second layer 36 of the first flap 16 of the card 12. The audio instruction unit 32 may have an actuating tab 37 which, when pulled, turns on the audio instruction unit 32, initiating playback of audio recording stored therein. Further, the actuating tab 37 may turn the audio instruction unit 32 off when the first flap 16 and the second flap 18 of the card 12 are moved to the closed position relative to one another. The actuating tab 37 may extend from the audio instruction unit 32 between the first layer 34 and the second layer 36 of the first flap 16 and may be fastened to the second flap 18 such that the actuating tab 37 is pulled thereby actuating the audio instruction unit 32 when the first flap 16 and second flap 18 are moved from the closed position to the opened position relative to one another. In the illustrated embodiment, the actuating tab is composed of an electrically insulating material and extends between first and second electrically conductive terminals 38, 40 of the audio instruction unit 32, as shown in FIGS. 5 and 6, when the first flap 16 and the second flap 18 of the card 12 are in the closed position relative to one another, and is moved from between the first and second electrically conductive terminals 38, 40 of the audio instruction unit 32, as shown in FIGS. 7 and 8, when the first and second flaps 16, 18 of the card 10 are moved toward the opened position relative to one another. The first and second electrically conductive terminals 38 and 40, respectively, are biased toward one another such that, when the actuating tab 37 is moved from between the first and second electrically conductive terminals 38, 40, they move into electrical contact with one another, completing an electric circuit and thereby turning on the audio instruction unit 32, which then plays the pre-recorded instructions via a speaker 42, which is coupled to the audio instruction unit 32 and affixed to the card 10 between the first and second layers 34, 36 of the first flap 16 together with the audio instruction unit 32. The audio instruction unit may be powered by one or more batteries 44 (three of which are shown in the illustrated embodiment).

The audio instruction unit 32 may be, for example, Information Storage Devices, Inc.'s model ISD-1020 A single-chip voice record/playback device, or any other desired electronic module capable of providing an audio recording in accordance with the principles of the present invention.

Audio instructions provided by a given assistance kit 10 provide concise explanation of how to provide the relevant assistance or perform the relevant procedure, including how to use any implements included in the assistance kit 10. By way of example only, instructions for performing CPR that may be provided by the audio instruction unit 32 of the assistance kit 10 may state: “Ensure the area is safe. Check the victim for responsiveness. If none, call 911 or local emergency number for help. Put on gloves, and check for breathing. If two people are present, one aids the victim, and one calls for help. If the victim is not breathing, start CPR immediately. CPR should be cycles of two breathes and 30 compressions. Check and clear victim's mouth of obstructions. Open the airway, tilt the victim's head back, lift the chin. Clear any material from around victim's mouth using gauze wipe. Place the filter of the CPR Lifemask® face shield over the victim's mouth. Pinch victim's nose closed with your finger and thumb of one hand while making a tight seal between the shield and the victim's mouth with your other hand. Start rescue breathing in accordance with accepted CPR practices. Give two breathes that make the chest rise and then 30 compressions. For adults and children, place the heal of one hand on the lower half of sternum between nipples. On adult, place your second hand directly on top. Children ages one through eight use only one hand. With elbows straight depress the sternum straight down, one and a half to two inches for adults, one-third to one-half the chest depth for children. Then allow the chest to return to normal position. Push fast, perform 30 compressions at the rate of 100 per minute. For infants, place two fingers below the nipple line on the lower half of the breast bone. Push down hard and fast, compressing the sternum one-third to one-half the chest depth and then allowing the chest to return to normal position. Continue to repeat. Continue cycle until an AED arrives, another rescuer or EMS takes over.”

In some embodiments, an outer surface of the storage sleeve 14 may bear a visible indication that the assistance kit provides audible instructions for providing the particular assistance or performing the particular procedure, as shown in FIG. 1.

As will be readily appreciated by those of ordinary skill in the art, the assistance kit 10 may be provided with a video display in addition to the audio instruction unit 32 in order that a user of the assistance kit 10 may be not only told but also shown how to provide the assistance for which the assistance kit 10 is intended to be used. Further, the audio instruction unit 32 may provide audible instructions in English, Spanish, or any other desired language in accordance with the principles of the present invention.

The exemplary assistance kit 10 described and illustrated herein is intended for use in providing CPR, but those skilled in the art will of course appreciate that an assistance kit providing audible instructions in accordance with the principles of the present invention may be beneficially employed in any of a virtually limitless variety of other situations. Examples of other medical conditions for which treatment may be facilitated using an assistance kit with a talking instruction card such as that described herein include: bleeding wounds, nose bleeds, ant, bee, wasp, and other insect bites or stings, dog, snake, scorpion, jellyfish, and other animal bites or stings, eye injuries, asthma, broken bones, contracted blood-borne pathogens, high fevers, diarrhea, accidental pill ingestion, poison ingestion of any type, contact poisons such as poison ivy, injuries requiring tourniquet, shock, injuries requiring application of heat or cold, bleeding and non-bleeding head injuries, infectious diseases such as hepatitis A, B, or C, meningitis, tuberculosis, HIV/AIDS, and influenza of any type, for example. Some other examples of medical treatments that may be facilitated by an assistance kit of the type described herein include treatment of severe bleeding lacerations using hemostatic powder, tourniquet application, treatment of first-, second-, and third-degree burns, and use of automated external defibrillators (AED's). An assistance kit with a talking instruction card such as described herein also may be beneficial in providing assistance in a wide variety of other situations where someone without the relevant experience may benefit from audible instructions, such as in, for example, how to using a condom, what to do for a menstrual period, what to do following unprotected sex, how to use high-risk gloves, how to safely handle and/or dispose of biohazardous materials, how to safely handle firearms, swimming pool safety, construction equipment safety, growing plants, trees, or vegetables of any particular type, castrating cows, livestock branding, handling the birth of a calf, and gambling, to name a few.

While the present invention has been described with reference to specific examples, which are intended to be illustrative only and not to be limiting of the invention, it will be apparent to those of ordinary skill in the art that changes, additions, or deletions in addition to those explicitly described above may be made to the disclosed embodiments without departing from the spirit and scope of the invention.

What is claimed is:

1. An assistance kit for providing a particular assistance or performing a particular procedure, the assistance kit comprising:
a card having first and second flaps wherein the first flap is hingedly coupled to the second flap such that the first flap and the second flap are moveable between an opened position relative one another and a closed position relative to one another; and
an audio instruction unit affixed to the card and adapted to provide audible instructions for providing the particular assistance or performing the particular procedure, wherein the audio instruction unit is activated by moving the first and second flaps of the card from the closed position to the opened position.

2. The assistance kit of claim 1, wherein the audio instruction unit is turned on by moving the first and second flaps of the card from the closed position to the opened position relative to one another, and wherein the audio instruction unit is off when the first and second flaps of the card are in the closed position relative to one another.

3. The assistance kit of claim 2, wherein the audio instruction unit has an actuating tab which, when pulled, turns on the audio instruction unit.

4. The assistance kit of claim 1, wherein the audio instruction unit has an actuating tab which, when pulled, turns on the audio instruction unit.

5. The assistance kit of claim 4, wherein the actuating tab turns the audio instruction unit off when the first and second flaps of the card are moved to the closed position relative to one another.

6. The assistance kit of claim 4, wherein the actuating tab extends from the audio instruction unit between the first and second layers of the first flap and is fastened to the second flap such that the actuating tab is pulled thereby actuating the audio instruction unit when the first and second flaps are moved from the closed position to the opened position.

7. The assistance kit of claim 1, wherein the first flap comprises first and second layers and wherein the audio instruction unit is disposed between the first and second layers of the first flap.

8. The assistance kit of claim 1, further comprising a storage sleeve defining a cavity sized to removably receive the card, wherein the storage sleeve defines an opening through which the card is removable from the cavity.

9. The assistance kit of claim 1, wherein an outer surface of the storage sleeve bears a visible indication that the assistance kit provides audible instructions for providing the particular assistance or performing the particular procedure.

10. The assistance kit of claim 1, further comprising a storage sleeve defining a cavity sized to removably receive the card when the first and second flaps are in the closed position, the storage sleeve defining an opening through which the card is insertable into and removable from the cavity.

11. The assistance kit of claim 1, wherein the first and second flaps of the card are sized and spaced to receive, between the first and second flaps when in the closed position, at least one implement usable for providing the particular assistance or performing the particular procedure, the assistance kit further comprising at least one implement useable for providing the particular assistance or performing the particular procedure, wherein the at least one implement is positionable between the first and second flaps of the card.

12. The assistance kit of claim 11, wherein the at least one implement includes at least one of a cardio-pulmonary resuscitation (CPR) mask, a pair of surgical gloves, a wipe, and a napkin.
